(19) United States
(12) Patent Application Publication
(10) Pub. No.: US 2004/0075229 A1
(43) Pub. Date: Apr. 22, 2004

(54) Infant carrier dolly

(75) Inventor: Brent Huntley, Folsom, CA (US)

Correspondence Address: Kenneth C. Brooks, P.O. BOX 10417, Austin, TX, 78766-1417, US

(73) Assignee: Brent Huntley, Folsom, CA

(21) Appl. No.: 10/686,094

(22) Filed: Oct. 15, 2003

Related U.S. Application Data
(60) Provisional application No. 60/418,970, filed on Oct. 16, 2002.

(51) Int. Cl. B62B 9/12

(52) U.S. Cl. 280/47.38

(57) ABSTRACT

The present invention is a stroller/car seat system and method of using the same to translationally displace a child over a surface that features a frame, a wheel assembly coupled to the frame to rotate about a roller axis, and a stop disposed on the frame opposite to the wheel. A handle is connected to pivot the frame about the roller axis between first and second positions, with the stop resting against the surface in the first position and being spaced-apart therefrom in the second position. A seat portion is connected to the frame.

### CROSS REFERENCE TO RELATED APPLICATIONS

The present application claims priority to U.S. provisional patent application No. 60/418,970, filed Oct. 16, 2002, entitled INFANT CARRIER DOLLY and having Brent Huntley listed as the inventor. Provisional patent application No. 60/418,970 is incorporated by references in its entirety herein.

### BACKGROUND OF THE INVENTION

The field of invention relates generally to child carriers. More particularly, the present invention is directed to child carriers that may be employed with infant/child seats.

Well-known designs of child carriers, commonly known as strollers, convert into child car seats. U.S. Pat. No. 4,822,064 to Hunter, describe a child's car seat that converts from a car seat into a stroller. The frame assembly and the wheel assembly in this type of design are attached to the car seat, which acts to increase the total weight of the apparatus even when the wheel assembly is not in use. A further disadvantage inherent in this type of design is that any dirt or mud acquired while using the device as a stroller is subsequently deposited in the car when the device is converted and used as a child's car seat.

The prior art also includes baby strollers in which the seat may be removed and used as a child's car seat. U.S. Pat. No. 4,768,795 to Mar, discloses car seats that must have specialized designs to enable their use on both a stroller and in an automobile. A drawback with this design is the difficulty in converting between the stroller and the car seat. Other drawbacks with this stroller/car seat system is that the same is difficult to control and maneuver in public places, such as stadiums, movie theaters, restaurants or airplanes.

A need exists, therefore, to provide an improved stroller/car seat converting system that is compact.

### SUMMARY OF THE INVENTION

The present invention provides a stroller/car seat system and method to translationally displace a child over a surface that features a frame, a wheel assembly coupled to the frame to rotate about a roller axis, and a stop disposed on the frame opposite to the wheel. A handle is connected to pivot the frame about the roller axis between first and second positions, with the stop resting against the surface in the first position and being spaced-apart therefrom in the second position. A seat portion is connected to the frame by a latching mechanism adapted to secure the seat portion to the frame. To that end, the latching mechanism may include a clamp to maintain a clamping force on the child car seat. These and other embodiments are described more fully below.

### BRIEF DESCRIPTION OF THE DRAWINGS

FIG. 1 is a side view of a stroller/car seat system, in accordance with one embodiment of the present invention;

FIG. 2 is a perspective view of a frame shown in FIG. 1;

FIG. 3 is a perspective view of the frame shown in FIG. 2, in accordance with a second embodiment of the present invention;

FIG. 4 is a side view of a car seat mounted to the frame shown in FIG. 3, in accordance with the second embodiment of the present invention;

FIG. 5 is a perspective view of the frame shown in FIG. 3, in accordance with a third embodiment of the present invention;

FIG. 6 is a detailed view of the frame shown in FIG. 5 coupled to a latching mechanism of a car seat;

FIG. 7 is a perspective view of the frame shown in FIG. 5, in accordance with a fourth embodiment of the present invention;

FIG. 8 is a perspective view of the frame shown in FIG. 5, in accordance with a fifth embodiment of the present invention;

FIG. 9 is a perspective view of the frame shown in FIG. 5, in accordance with a sixth embodiment of the present invention;

FIG. 10 is a detailed view of the frame shown in FIG. 9 coupled to a latching mechanism of a car seat;

FIG. 11 is a perspective view of the frame shown in FIG. 5, in accordance with a seventh embodiment of the present invention; and

FIG. 12 is a detailed view of the frame shown in FIG. 11 coupled to a latching mechanism of a car seat.

### DETAILED DESCRIPTION OF THE PREFERRED EMBODIMENTS

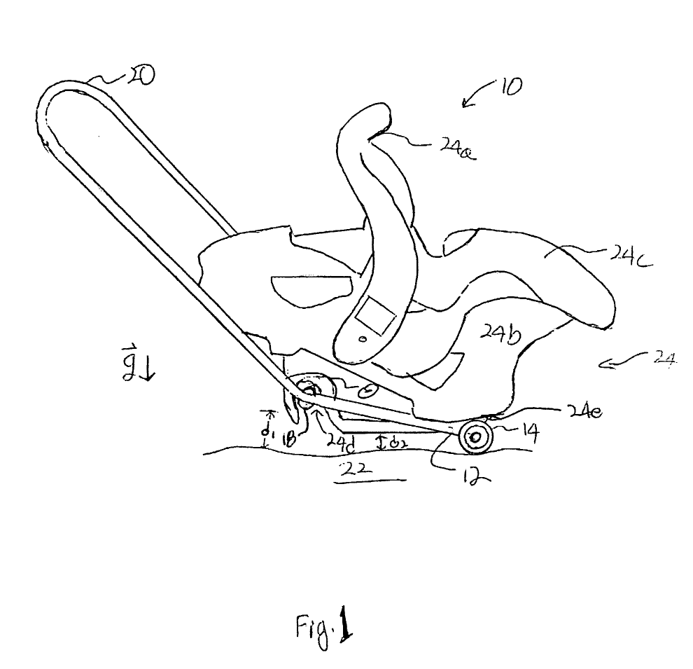

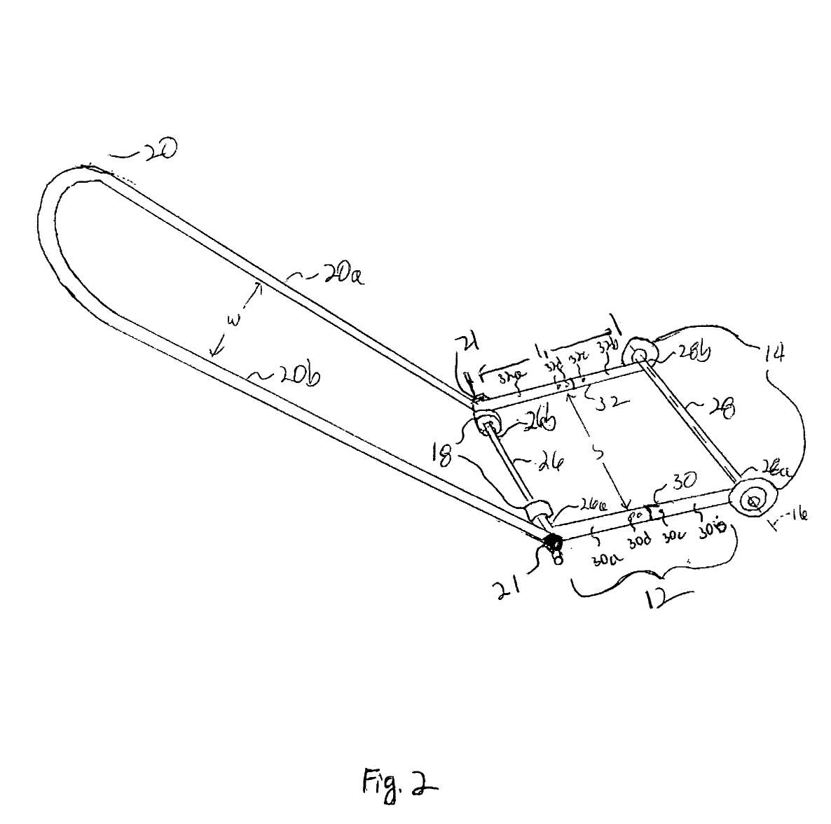

Referring to FIGS. 1 and 2, a stroller/car seat system 10, in accordance with one embodiment of the present invention, includes a frame 12, a wheel assembly 14, coupled to frame 12 to rotate about a roller axis 16. Stops 18 are disposed on frame 12 opposite to wheel assembly 14. A handle 20 is connected to frame 12 to pivot frame 12 about roller axis 16. In this manner a distance, between stop 18 and a surface 22 over which stroller/car seat system 10 traverses may be varied. Resting on frame 12 is a seat portion 24.

Frame 12 includes two spaced apart cross-members 26 and 28 that extend parallel to roller axis 16. Extending between opposed ends 26aand 28aof cross-members 26 and 28 is a first support bar 30. Extending between opposed ends 26band 28bof cross-members 26 and 28 is a second support bar 32. Although stops 18 may be fixedly attached to cross-member 26, in the present embodiment, stops 18 are rotatably disposed about cross-member 26.

Seat portion 24 may be any manufactured car seat. In the present example seat portion 24 includes a handle 24apivotally connected to a base 24b, with base 24bbeing covered with a soft fabric 24c connected to said frame 12. To securely affix seat portion 24 to frame 12, base 24bincludes recessing, one of which is shown as 24d. Cross-member 26 fits within recess 24d with a portion of base 24e, disposed opposite to recess 24d resting against cross-member 28. In this manner, stroller/car seat system 10 may be translated over surface 22 while minimizing the possibility that seat portion 24 decouple from frame 12. Specifically, by receiving cross-member 26 into recess 24d minimizes decoupling of seat portion 24 from frame 12 due to forces not parallel to gravity, g. The aforementioned forces result from pushing or pulling on handle 20 by a user, as well as centrifugal forces that result from turning of the stroller/car seat system 10 while a force is applied to handle 20 to translate the same with respect to surface 22.

To further reduce decoupling of frame 12 from seat portion 24, spacing, s, between support bars 30 and 32 is established to be greater than a width of seat portion 24, measured parallel to roller axis 16. As a result, when distance “d₁” is established to have recess 24d receive cross member 26, support bars 30 and 32 flank opposing sides of base 24b. As a result, support bars 30 and 32 operate as stops to prevent seat portion 24 from decoupling from frame 12 in a direction parallel to roller axis 16. Additionally, handle 20 may operate as a stop by having opposed portions 20a and 20b being spaced apart a width, w, such that base 24bmay be flanked thereby, as well.

Support bars 30 and 32 may be rigid defining a fixed length, l₁. However, to accommodate seat portions 24 of differing sizes, support bars 30 and 32 may have a length, l₁, measured between cross-members 26 and 28 that may be varied. To that end, support bar 30 may include telescoping members 30a and 30b, with telescoping member being received within telescoping member 30b. The relative longitudinal position between telescoping members 30a and 30b may be fixed by the use of a pin 30c. Specifically, telescoping member 30a includes a plurality of spaced-apart apertures 30d and pin 30c passes through telescoping member 30b and is received within one of apertures 30d forming an interference fit therewith. Similarly, support bar 32 may include telescoping members 32a and 32b, with telescoping member 32a being received within telescoping member 32b. The relative longitudinal position between telescoping members 32a and 32b may be fixed by the use of a pin 32c. Specifically, telescoping members 32a and 32b includes a plurality of spaced-apart apertures 32d and pin 32c passes through telescoping member 32b and is received within one of apertures 32d forming an interference fit therewith.

To easily decouple seat portion 24 from frame 12 seat portion 24 may be moved opposite to the direction of gravity, g, such as by lifting handle 24a. In addition, handle 20 may be moved to minimize distance, “d₁”, whereby cross-member 26 is removed from recess 24d, with stops 18 resting on surface 22. As a result, angle θ, is selected so that when cross-member 26 is positioned within recess 24d, a portion of base 24e is spaced-apart from surface 22 a sufficient distance, “d₂”, to enable roller/car seat system 10 to roll freely over surface 22.

To enhance the invention, handle 20 may be pivotally attached to frame 12 to be collapsible. In this manner, a pair of bolts 21 may couple handle 20 to frame 12 and may be loosed to allow handle 20 to fold flat in superimposition with frame 12, extending parallel thereto. In this manner, the handle 20 and frame 12 combination are made collapsible and easy to carry. Couple the collapsible handle 20 with the varying length L of members 30 and 32 and further reduction of size in the handle 20 and frame 12 combination is afforded. In addition, if desired, opposed portions 20a and 20b of handle 20 may be provided with a telescoping function, in a manner similar to the telescoping function of members 30 and 32, to further reduce the size of handle 20.

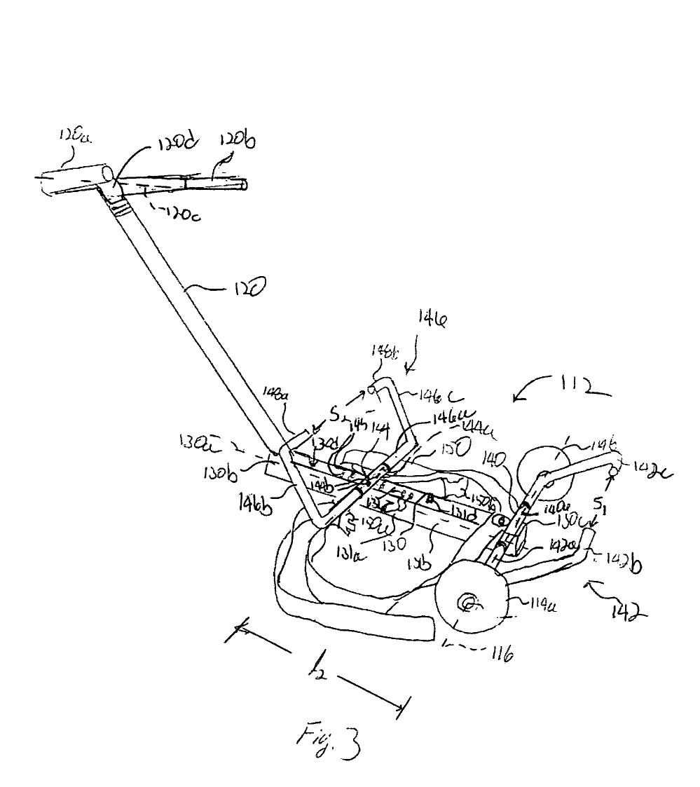

Referring to FIG. 3, another embodiment of frame 112 includes a support bar 130 extending along a longitudinal axis 130a, with handle 120 coupled to a first end 130b of support bar 130. A wheel assembly is attached to a second end 130c of support bar 130, disposed opposite to first end 130b. The wheel assembly includes a journal 140 attached to a side 130d of support bar 130 and has a longitudinal axis 140a that extends transversely to longitudinal axis 130a. Journal 140 may be attached to side 130d using any known technique, e.g., brazing, soldering, adhesives, fasteners and the like. A first seat support device 142 is disposed proximate to second end 130c. First support device 142 includes a rod 142a that extends through journal 140. Wheels 114a and 114b are connected to opposed ends of rod 142a to rotate about a roller axis 116, which extends transversely to longitudinal axis 130a and parallel to longitudinal axis 140a. Extending from rod 142a, away from first end 130b, is a pair of spaced-apart support members 142b and 142c, defining a space, S₂, therebetween. Support members 142b and 142c lie in a common plane that forms an oblique angle with respect to side 130d. A second journal 144 is connected to side 130d and is positioned between first end 130b and journal 140. Second journal 144 may be attached to side 130d using any known technique, e.g., brazing, soldering, adhesives, fasteners and the like. Journal 144 has a longitudinal axis 144a extending parallel to longitudinal axis 140a. A second seat support device 146 is positioned between first end 130b and second end 130c and includes a rod 146a extending through journal 144. In this manner second seat support device 146 is rotatably mounted to support bar 130 to rotate about axis 144a of journal 144, while maintaining a fixed position along axis 130a. The angular position of rod 146a about axis 144a may be fixed employing fasteners, such as screws 144b. Extending from rod 146a, away from second end 130c, is a pair of spaced-apart support members 146b and 146c. Support members 146b and 146c lie in a common plane that forms an oblique angle with respect to longitudinal axis 130a. Support member 146b includes a detent 148a that extends from an end thereof, positioned opposite to rod 146a, toward support member 146c. Support member 146c includes a detent 148b that extends from an end thereof, positioned opposite to rod 146a, toward support member 146b. Detents 148a and 148b are spaced-apart, defining a space, S₂, therebetween. Also connected to side 130d, such as via a bolt, is a strap 150. Handle 120 extends from first end 130b, terminating in a pair of spaced-apart grips 120a and 120b.

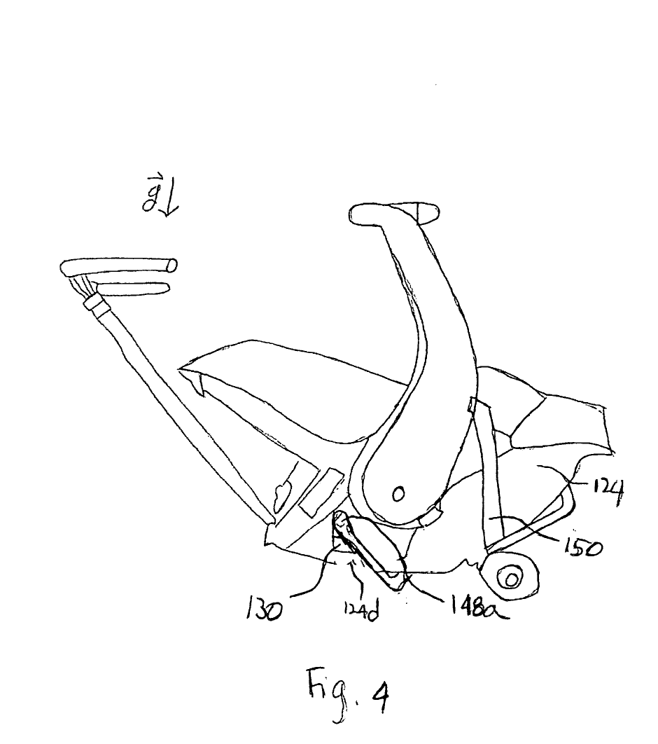

Referring to both FIGS. 3 and 4, seat portion 124 is securely affixed to frame 112 by having detents 148a and 148b received within a recess 124d located on a side of seat portion 124 facing support bar 130. This configuration is shown as detent 148a being received by recess 124d. It should be understood that detent 148b is received within a similar recess formed on a side of seat portion 124, which is not shown. To minimize decoupling of seat portion 124 from frame 112 due to forces not parallel to gravity, g, strap 150 may be fixedly secured to seat portion 124 by coupling together of the opposed ends 150a and 150b of strap 150.

To provide flexibility in varying a length l₂ between first and second support devices 142 and 146, screws 144b may be replaced with pins and support bar 130 may include a plurality of aperture pairs 145, forming-a-pin-and-hole-system. The pins 144b may be placed into aperture pairs 145 to form an interference fit therewith providing frame 112 with the ability to select a desired length, l₂, appropriate for a seat portion 124 to be mounted thereto. Alternatively, or in addition thereto, support bar 130 may comprise of two telescoping members 131a and 131b, one of which is received in the other. One or more apertures 131c may be including in, for example, telescoping member 131a and a pin 131d passes through telescoping member 131b and fits into one of aperture 131c forming an interference fit therewith. The length, l₂, may also be selected in this fashion.

The magnitude of spaces S₁ and S₂ may also be varied by forming rods 142a and 146a, respectively. This may be achieved by forming rods 142a and 146a from telescoping members 131a and 131b having a pin-and-hole-system similar to that described above. Additionally, rod 142a may be disposed within journal 140 to rotate about axis 140a. To that end, the position of rod 142a may be fixed by a pin-and-hole-system (not shown) or by forming an interference fit with journal 140 by the diameter of journal 140 being slightly smaller than the diameter of rod 142a. Similarly, rod 146a may be disposed in journal 144 to rotate about axis 144a. This facilitates folding of both seat support devices 142 and 146 toward or away from each other making frame 112 collapsible. Additionally, handle 120 may be telescoping and/or pivotally connected to frame 112 using, for example, a bolt and nut system (not shown) to further collapse the handle 120 and frame 112 combination. Also, grips 120a and 120b may be pivotally mounted to handle 120 to rotate about axis 120c. To that end, a clamping mechanism 120d may be coupled between handle 120 and grips 120a and 120b to be selectively tightened and loosened. In this manner, clamping mechanism 120d facilitates rotation of grips 120a and 120b about axis 120c and securely fixing grips 120a and 120b in differing positions about axis 120c. With this configuration, the handle 120 and frame 112 combination may be fully collapsible making the same easier to transport in a compact space.

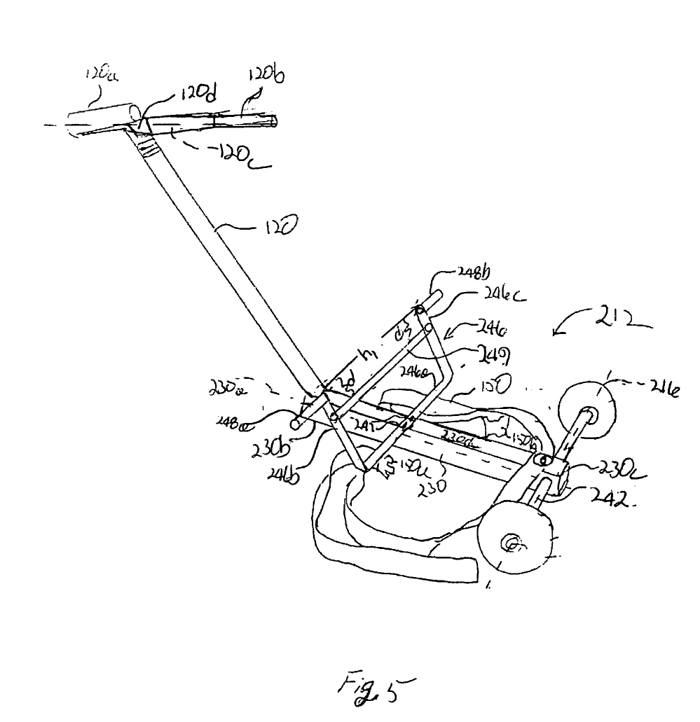

Referring to FIGS. 3 and 5, another embodiment of frame 212 abrogates first seat support device 142 and replaces the same with a straight rod 242. Rod 242 extends through support bar 230, proximate to second end 230c, and wheels 114a and 114b are connected to opposed ends of rod 242. In this fashion, support bar 230 functions as a journal, allowing rod 242 to rotate about a roller axis 216, which extends transversely to longitudinal axis 230a of support bar 230.

A second seat support device 246 is positioned between first end 230b and second end 230c and attached to side 230d using any known means, e.g., brazing, soldering, adhesives, fasteners and the like. As shown, second seat support device 246 includes a rod 246a that is affixed to support bar 230 using screws 247. Rod 246a extends transversely to axis 230a. Extending from opposed ends of rod 246a, away from second end 230c, is a pair of spaced-apart support members 246b and 246c. Support member 246b extends from rod 246a, terminating in a detent 248a . Support member 246c extends from rod 246a, terminating in a detent 248b, and support members 246b and 246c lie in a common plane that forms an oblique angle with respect to side 230d. Detent 248a extends from support member 246b in a direction parallel to rod 246a and away from detent 248b. Detent 248b extends from support member 246c in a direction parallel to rod 246a and away from detent 248a . In this manner, a hiatus, h, is defined between detents 248a and 248b. Extending between members 246b and 246c is a central rod 249. Central rod 249 extends parallel to rod 246a and is spaced apart from ends at distance, d, of support members 246b and 246c from which detents 248a and 248b extend. It should be understood that hiatus, h, may be adjusted by providing central rod 249 and rod 246a with telescoping members employing a pin-and-hole-system as discussed above with respect to rods 142a and 146a in FIG. 3. Referring again to FIG. 5, seat support device 246 may also be moveably mounted to support bar 230 in a fashion similar to the mounting of support bar 130 and seat support device 146 discussed with respect to FIG. 3.

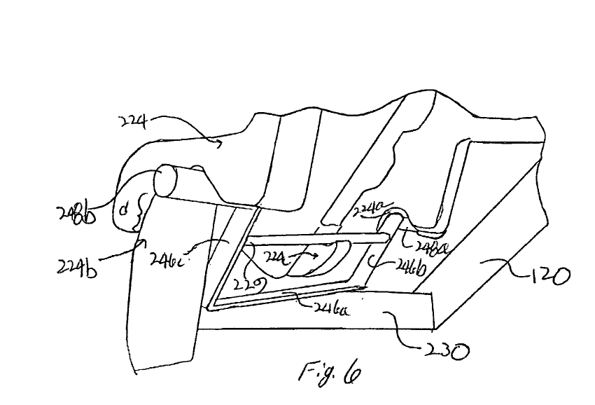

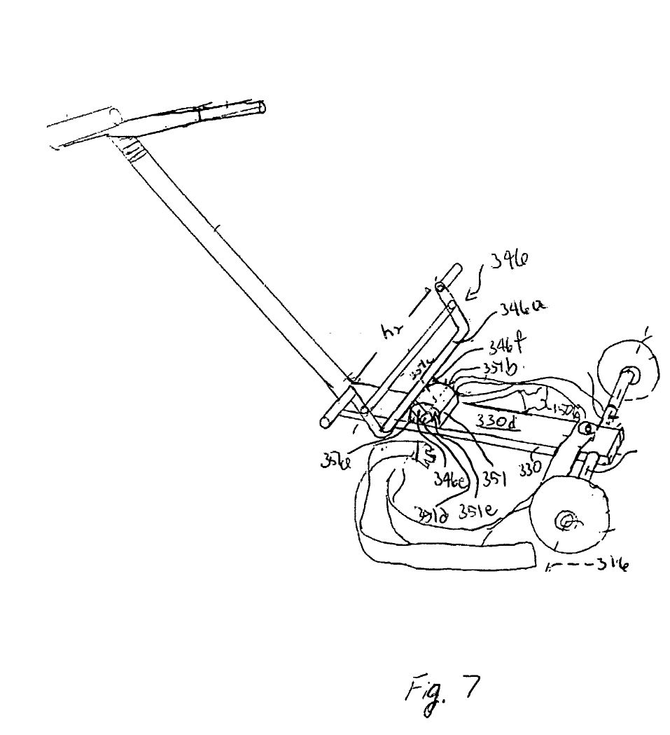

Referring to FIGS. 5 and 6, seat portion 224 is securely affixed to frame 212 by having detents 248a and 248b received within recesses 224aand 224b, respectively, which face support bar 230. Further, distance, d, is selected so that central rod 229 couples to a latch mechanism 224c that is included with seat portion 224. Latch mechanism 224c is of a conventional type commonly associated with car seats manufactured for children by Graco®. As a result, latch mechanism 224c is typically resiliently-biased by a spring(not shown) to reciprocate between a catch position, as shown, or be spaced-apart from central rod 229 to allow seat portion 224 to be decoupled from frame 212. As mentioned with respect to the embodiment discussed with respect to FIG. 4, strap 150 may be fixedly secured about seat portion 224 by coupling together of the opposed ends 150a and 150b of strap 150. To add greater accommodation to differing the differing types and positions of latch mechanisms 224c on seat portion 224, second seat support device 246 could be moveably attached to support bar 230. One manner in which to moveably attach second seat support device 246 to support bar 230 is shown in FIG. 7.

Referring to FIG. 7, second seat support device 346 is coupled to support bar 330 via a pivotal mount 351. Specifically, pivotal mount 351 is connected to side 330d. Second support member 346 includes two spaced apart rotary arms 346e and 346f that extend from rod 346a, terminating on opposed sides 351a and 351b of pivotal mount 351. An end of each of rotary arms 346e and 346f disposed opposite to rod 346a are coupled to an axle 351c. Axle 351c extends through opposing sides 351a and 351b in a direction parallel to roller axis 316. In this arrangement, second seat support device 346 may be rotated about axle 351c, with the angular position of second seat support device 346 being fixed by compressing rotary arms 346e and 346f against mount 351. This may be achieved, for example, using a bolt and nut combination as axle 351c. Tightening the nut (not shown) with sufficient force compresses rotary arms 346e and 346f against opposing sides 351a and 351b holding second seat support device 346 in position. Alternatively, a plunger-tab-assembly may also be employed to fix the angular position of second seat support device 346. In this manner, a plunger 351d includes a tab (not shown) extending into one of a plurality of holes (not shown) in mount sidewall 351e. Plunger 351d is resiliently biased, for example by a spring (not shown) to having the tab (not shown) disposed in one of the plurality of holes in mount sidewall 351e. To change an angular position of seat support device 346, plunger 351d is pulled or pushed in a direction parallel to axle 351c, removing tab (not shown) from on the plurality of holes (not shown) in mount sidewall 351e. Seat support device 346 is then moved to the desired position so that the tab (not shown) on plunger 351d is received in another one of the plurality of holes (not shown) in mount sidewall 351e. This fixes the position of seat support device 346 in a new angular position. Support bar 330 may be telescoping in the manner discussed above with respect to support bars 130 and 230 of FIGS. 3 and 5, respectively, or the same may be solid. Additionally, the distance h₂ shown in FIG. 7 may be made variable by making the appropriate elements of seat support device 346 telescoping, as described with respect to seat support device 246 discussed with respect to FIG. 5.

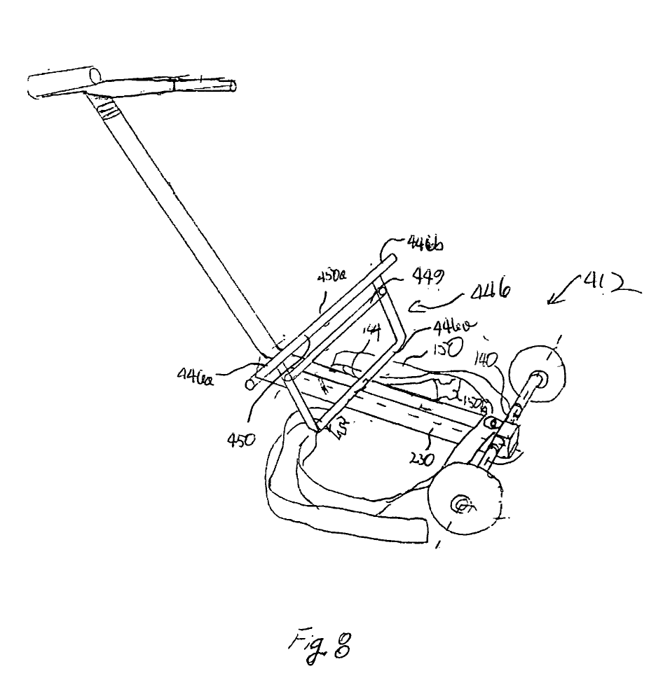

Referring to FIGS. 5, 6 and 8, another embodiment of second seat support device 446 is shown mounted to support bar 230. In this configuration second seat support device 446 includes first and second central rods 449 and 450, respectfully. First central rod 449 is identical in shape, size and position as central rod 249 discussed with respect to FIG. 5. Referring again to FIG. 8, second central rod 450 has a central portion 450a that extends through hiatus, h₁. Detents 446a and 446b are defined by opposed end portions of second central rod 450, with detent 446a extending away from detent 446b and detent 446b extending away from detent 446a. With this arrangement, frame 412 may be accommodating to latch mechanism 224c of other seat portion 224 manufactures, such as Evenflo®. It should be understood that second seat support device 446 may be provided with movement by incorporating mount 351, shown in FIG. 7 in the embodiment shown in FIG. 8. Additionally, support bar 230 may be telescoping in the manner discussed above with respect to support bar 130 discussed with respect to FIG. 3, or the same may be solid. Additionally, rods 450, 449 and 346a may be telescoping and employ a pin-and-hole-system similarly to that discussed with respect to rod 146a discussed with respect to FIG. 3. Moreover, referring to FIGS. 3, 5, 7 and 8, additional versatility of seat support devices 142, 146, 246, 346 and 446 may be provided by forming the same from a flexible rubber or polymer material.

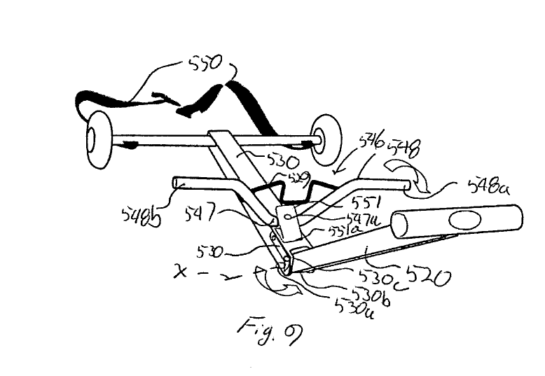

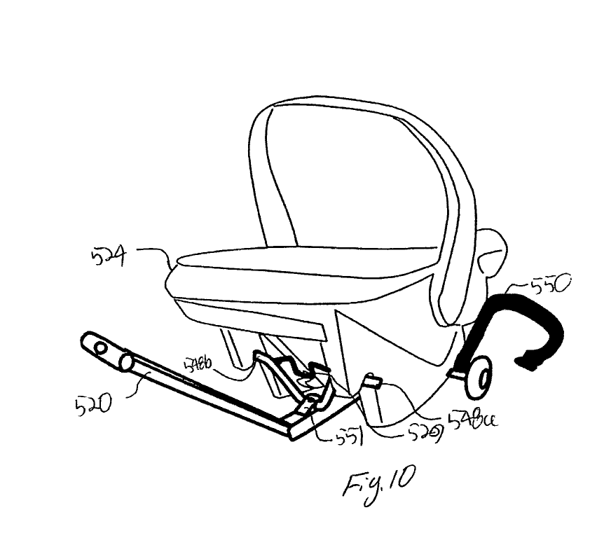

Referring to FIGS. 9 and 10, another embodiment of the present invention that is substantially similar to the embodiments shown above in FIGS. 5 and 7, excepting that strap 550 is connected to rod 542 and a second seat support device 546 coupled to support bar 530 via a pivotal mount 551. Specifically, pivotal mount 551 is a spring clip, with one end 551a and support fixedly attached to support bar 530. A central portion 547 of seat support device 546 is received within spring clip 551 and compressed therebetween when in the operational position. Rotational movement between spring clip 551 and central portion 547. In this manner, pin 547a may be removed to allow pivotal movement between seat support device 546 and spring pin 551 so that seat support device 546 may be collapsed, resting against support bar 530. In the operation position, seat support device 546 extends upwardly away and outwardly from support bar 530 terminating in a pair of detents 548a and 548b disposed on opposing sides of support bar. Extending between opposed detents 548a and 548b is a central rod 529, a middle portion of which extends downwardly toward central portion 547. Additionally, a first end 530b of handle 520 is coupled to support bar to pivot about axis X though a double pin system. Specifically, pivot pin 530a pivotally attaches handled 520 to support bar 530. A second pin 530c is resiliently biased via spring 532 to pass through an opening in support bar 530 and into an aperture (not shown) in handle 520. With this configuration, seat portion 524 may be coupled as shown.

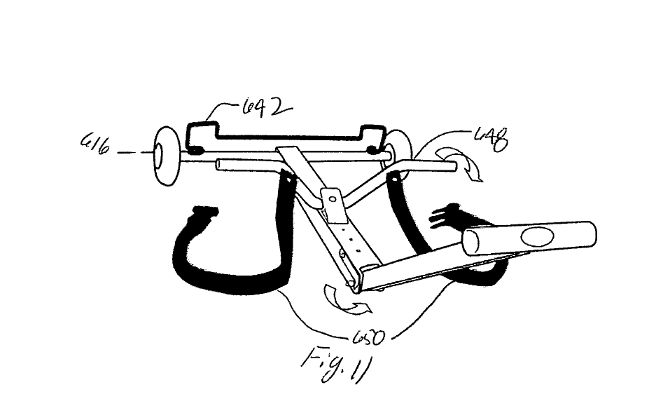

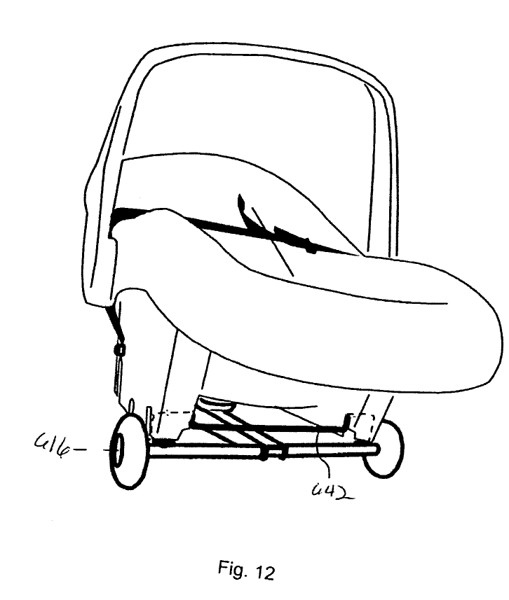

Referring to FIGS. 11 and 12 in yet another embodiment, which is substantially similar to the configuration shown in FIG. 9, excepting that seat support device 628 does not include central rod 529, shown in FIG. 9. Additionally, strap is coupled to seat support device 648, shown in FIG. 11. Finally, a forward seat support device 642 is mounted proximate to roller axis. In this manner seat portion to rod 642 may be coupled as shown in FIG. 12.

The embodiments of the present invention described above are exemplary and other modifications may be made thereto while remaining within the scope of the present invention. For example, although the description has discussed use of wheels with an axle it is entirely possible to omit a common axle of the wheels and to have the wheels mounted to the frame with independent axles. Further the axles may rotate or may be fixed, with the wheels having ball-bearings. The scope of the invention should, therefore, be determined not with reference to the above description, but instead should be determined with reference to the appended claims along with their full scope of equivalents.

What is claimed is:

1. A carrier to translationally displace a child over a surface, comprising:
a frame;
a wheel assembly coupled to said frame to rotate about a roller axis;
a stop disposed on said frame opposite to said wheel; and
a handle connected to pivot said frame about said roller axis between first and second positions, with said stop resting against said surface in said first position and being spaced-apart therefrom in said second position.

2. The carrier as recited in claim 1 further including a seat portion connected to said frame.

3. The carrier as recited in claim 1 wherein said handle and said frame are collapsible.

4. The carrier as recited in claim 1 further including a fastening system adapted to secure a child car seat to said frame.

5. The carrier as recited in claim 4 wherein said fastening system includes a latching mechanism having a clamp to maintain a clamping force between said child car seat and said frame.

6. The carrier as recited in claim 4 further including first and second seat support devices spaced apart a distance 1, with one of said seat support devices adapted to couple with said latching mechanism and being moveably mounted to said frame to vary a magnitude of said distance, l.

7. The carrier as recited in claim 4 further including a seat support device adapted to couple with said fastening system, with said frame further including a support bar having a longitudinal axis, said support bar extending between said handle and said roller axis and said seat support device being moveably attached to said support bar to pivot along a pivot axis that extends transversely to said longitudinal axis.

8. The carrier as recited in claim 1 wherein said frame includes a support bar having a length associated therewith, with said frame including a coupling mechanism to vary said length.

9. The infant carrier as recited in claim 1 wherein said handle can move between extended and retracted positions, with said handle being positioned against said frame in said retracted position and spaced-apart therefrom in said extended position.

10. The infant carrier as recited in claim 9 wherein said handle further includes a plurality of intermediate positions, with said extended position defining a first length for said handle and said retracted position defining a final length for said handle, with each of said plurality of intermediate positions defining an intermediate length, with said intermediate length associated with each of said plurality of intermediate positions being greater than said final length and less than said first length.

11. The infant carrier of claim 1 includes two wheel assemblies that are mounted relative to the center of gravity in a position to minimize required lifting forces and increase operational mobility.

12. A carrier to translationally displace a child over a surface, comprising:
a frame having a support bar, with said support bar extending along a longitudinal axis;
a wheel assembly coupled to said frame to rotate about a roller axis;
a stop disposed on said frame opposite to said wheel;
a handle connected to pivot said frame about said roller axis between first and second positions, with said stop resting against said surface in said first position and being spaced-apart therefrom in said second position; and
a seat support device coupled to said support bar, with said seat support device being space-apart from said roller axis a distance 1; and
means, connected to said frame, for varying a magnitude of said distance l.

13. The carrier as recited in claim 12 wherein said means for varying further includes connecting a pivot between said seat support device and said frame to facilitate movement of said seat support device around a pivot axis, with said pivot axis extending transversely to said longitudinal axis.

14. The carrier as recited in claim 12 wherein said means for varying further includes a pin-and-hole system connected between said seat support device and said support bar to moveably connect said seat support device to move along said longitudinal axis.

15. The carrier as recited in claim 12 wherein said means for varying further includes providing said support bar with first and second telescoping members connect to selective vary dimensions of said support bar along said longitudinal axis.

16. The carrier as recited in claim 12 further including means, coupled to said frame, for allowing said child to assume a seated position.

17. The carrier as recited in claim 16 wherein said means for allowing comprises a child car seat having a latching mechanism that includes a clamp to maintain a clamping force between said child car seat and said frame.

18. The carrier as recited in claim 17 further including an additional seat support device connected to said support bar proximate to said roller axis, with said clamp being coupled to said seat support device.

19. The carrier as recited in claim 18 wherein said handle can move between extended and retracted positions, with said handle being positioned against said frame in said retracted position and spaced-apart therefrom in said extended position and includes a plurality of intermediate positions, with said extended position defining a first length for said handle and said retracted position defining a final length for said handle, with each of said plurality of intermediate positions defining an intermediate length, with said intermediate length associated with each of said plurality of intermediate positions being greater than said final length and less than said first length.

20. The carrier of claim 19 includes two wheel assemblies mounted relative to the center of gravity in a position to minimize required lifting forces and increase operational mobility.

21. A method for displacing a child translationally with respect to a surface, said method comprising:
providing a frame;
providing a wheel assembly coupled to said frame to rotate about a roller axis;
providing a stop disposed on said frame opposite to said wheel;
providing a handle connected to pivot said frame about said roller axis between first and second positions; and
selectively rolling said frame by moving said handle to said second position, with said stop being spaced-apart from said surface in said second position.

22. The method as recited in 21 further including latching a child car seat to said frame.

23. The method as recited in claim 21 further including moving said handle between said extended and retracted positions to selectively vary a moment arm.
